(19) United States
(12) Patent Application Publication
(10) Pub. No.: US 2016/0339886 A1
(43) Pub. Date: Nov. 24, 2016

(54) VARIABLE ELECTROMAGNETIC BRAKE PEDAL FEEL SIMULATION

(71) Applicant: TOYOTA MOTOR ENGINEERING & MANUFACTURING NORTH AMERICA, INC., Erlanger, KY (US)

(72) Inventors: Robert C. MacArthur, Ypsilanti, MI (US); Gregg J. Overfield, Canton, MI (US)

(73) Assignee: TOYOTA MOTOR ENGINEERING & MANUFACTURING NORTH AMERICA, INC., Erlanger, KY (US)

(21) Appl. No.: 14/720,446

(22) Filed: May 22, 2015

(51) Int. Cl. B60T 8/40; B60T 7/04

(52) U.S. Cl. CPC B60T 8/4081; B60T 7/042

(57) ABSTRACT

An electromagnetic brake pedal feel simulation system may simulate the feel of a manual brake pedal when force is applied to a power-assist brake pedal mounted to an arm. The electromagnetic brake pedal feel simulation system may include an electromagnetic movement resistance device. The device may mechanically couple to the power-assist brake pedal pad or arm and may apply a controllable amount of force against a braking force that is applied to a power-assist brake pedal pad that is a function of the amount of a drive signal current. The electromagnetic movement resistance device may include a pair of magnets having both of their north or south poles facing each other and that come closer together as force is applied to the power-assist brake pedal pad. At least one of the magnets may be an electromagnetic to which the drive signal current may be applied. The electromagnetic brake pedal feel simulation system may include a brake pedal position sensor that senses the position of the power-assist brake pedal pad or arm. A controller may be electrically connected to at least one electromagnet and to the brake pedal position sensor. The controller may cause the amount of the drive signal current to vary based on the position of the power-assist brake pedal pad or arm, as sensed by the sensor.

### BACKGROUND

1. Technical Field

This disclosure relates to power-assisted brake pedal feel simulators that simulate the feel of a manual brake pedal when force is applied to a power-assisted brake pedal.

2. Description of Related Art

A power-assisted brake pedal may not inherently provide much resistance to the application of force to the pedal. A device may be added to provide that resistance, thus providing a more natural feeling to the operator of a vehicle containing the power-assisted brake.

A brake pedal feel simulation device may include mechanical components to generate the needed resistance, such as one or more springs, a vacuum system, and/or a hydraulic system. These devices, however, may only be able to provide a single brake pedal distance/force profile that may not accurately simulate the brake pedal-distance/force profile of a manual brake pedal throughout its movement trajectory.

Different brake pedal distance/force profiles may also be desired when changing the mode of operation of a vehicle containing the power-assisted brake pedal and/or when installing the feel simulator in different vehicles that require different distance/force profiles. However, the brake pedal distance/force profile of a particular simulator may also not be able to be easily modified. Instead, the entire assembly may need to be replaced with a different one in order to obtain a different brake pedal distance/force profile.

A brake pedal feel simulator can utilize an electromagnet to generate the desired resistance. See, e.g., European patent EP1047584B1. However, such a simulator may still not accurately simulate the brake-pedal-distance/force profile of a manual brake pedal, nor does such a design appear to provide any means to change its profile for different driving modes and/or vehicles.

### SUMMARY

An electromagnetic brake pedal feel simulation system may simulate the feel of a manual brake pedal when force is applied to a power-assist brake pedal mounted to an arm. The electromagnetic brake pedal feel simulation system may include an electromagnetic movement resistance device. The device may mechanically couple to the power-assist brake pedal pad or arm and may apply a controllable amount of force against a braking force that is applied to a power-assist brake pedal that is a function of the amount of a drive signal current. The electromagnetic movement resistance device may include a pair of magnets having both of their north or south poles facing each other and that come closer together as force is applied to the power-assist brake pedal pad. At least one of the magnets may be an electromagnetic to which the drive signal current may be applied. The electromagnetic brake pedal feel simulation system may include a brake pedal position sensor that senses the position of the power-assist brake pedal or arm. A controller may be electrically connected to at least one electromagnet and to the brake pedal position sensor. The controller may cause the amount of the drive signal current to vary based on the position of the power-assist brake pedal pad or arm, as sensed by the sensor.

The controller may include a memory containing data indicative of an amount of drive signal current that the controller should cause to be applied to at least one electromagnet for each of multiple different positions of the power-assist brake pedal or arm, as sensed by the sensor.

The controller may use an algorithm to determine the amount of drive signal current that the controller should cause to be applied to at least one electromagnet based on the position of the power-assist brake pedal pad or arm, as sensed by the sensor.

One of the magnets may be a permanent magnet or both of the magnets may be electromagnetic.

The pair of magnets may move in unison with movement of the power-assist brake pedal or arm.

The controller may include a mode switch that enables a user of the electromagnetic brake pedal feel simulation system to select one of multiple modes of operation of a vehicle in which the electromagnetic brake pedal feel simulation system is installed. The controller may cause the amount of drive signal current to vary based on the mode of operation selected by the user.

The multiple modes of operation may include a normal mode, a sport mode, and a racing mode.

The controller may include a memory containing data indicative of an amount of drive signal current that the controller should cause to be applied to at least one electromagnet for each of multiple different positions of the power-assist brake pedal or arm, as sensed by the sensor, during each of the multiple modes.

The controller may use an algorithm to determine the amount of drive signal current that the controller should cause to be applied to the at least one electromagnet for each of multiple different positions of the power-assist brake pedal or arm, as sensed by the sensor, during each of the multiple modes.

Two vehicles may each contain an electromagnetic brake pedal feel simulation system for simulating the feel of a manual brake pedal during power-assist breaking. The electromagnetic brake pedal feel simulation system in each vehicle may be identical in hardware, but may provide a materially different brake pedal feel simulation.

Each of the electromagnetic brake pedal feel simulation systems may include a memory containing data indicative of how the simulation should feel and the data in each memory may be different.

Each of the electromagnetic brake pedal feel simulation systems may use an algorithm to indicate how the simulation should feel and the algorithm in each system may be different.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example of various components that may be in a variable electromagnetic brake pedal feel simulation system.

FIG. 2 illustrates an example of electronic components that may be used in connection with the variable electromagnetic brake pedal feel simulation system illustrated in FIG. 1.

FIG. 3 illustrates graphs of example amounts of repulsive force that the controller in FIG. 2 may cause the magnets in FIGS. 1 and 2 to apply to the power-assist brake pedal at different positions of the power-assist brake pedal and during each of three different modes of operation. FIGS. 4A-4C illustrate some of the same data in a table format.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

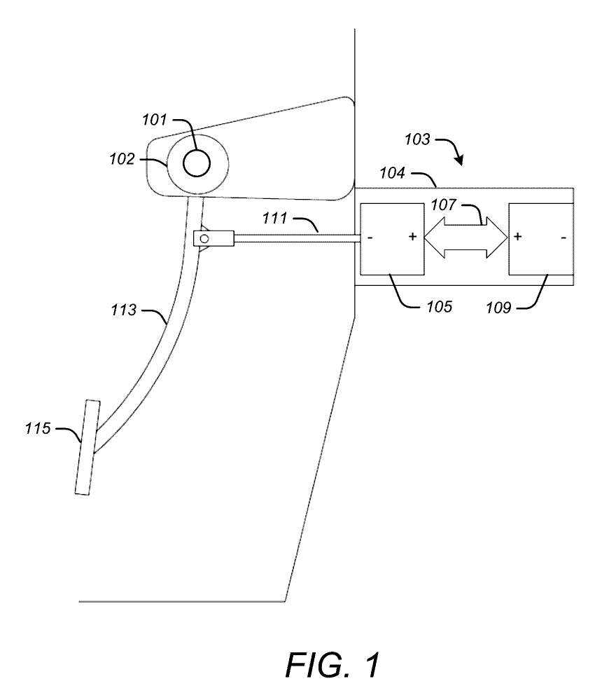

FIG. 1 illustrates an example of various components that may be in a variable electromagnetic brake pedal feel simulation system. As illustrated in FIG. 1, the variable electromagnetic brake pedal feel simulation system may include a position sensor 101, an electromagnetic movement resistance device 103 that may include a housing 104 and magnets 105 and 109, linkage 111, a brake pedal arm 113, a power-assist brake pedal pad 115, and a pivot 102.

The power-assist brake pedal pad 115 may be attached to the brake pedal arm 113 which may rotate about the pivot 102 to which may be attached the position sensor 101. The position sensor 101 may sense the position of the brake pedal pad 115 based on the rotational movement that takes place between the brake pedal arm 113 and the pivot 102.

The position sensor 101 may be of any type. For example, the position sensor 101 may be a potentiometer or a resolver. The position sensor 101 may be connected to a power-assist breaking system so as to transfer information about the position of the power-assist brake pedal pad 115 to the power-assist brake system so that it can effectuate application of the brakes in response to depression of the power-assist brake pedal pad 115.

The housing 104 may be configured to house the magnets 105 and 109. The magnet 109 may be fixed and stationary with respect to the housing 104, while the magnet 105 may move within the housing 104, much like a piston moves within a cylinder. The magnet 105 may be able to move toward the magnet 109 in response to depression of the power-assist brake pedal pad 115 by virtue of the linkage 111 between the brake pedal arm 113 and the magnet 105. Thus, as the power-assist brake pedal pad 115 is depressed, the magnet 105 may move closer to the magnet 109. The linkage 111 could instead be directly connected to the power-assist brake pedal pad 115. The linkage 111 does not need to be a single arm or even straight, but could instead be formed of multiple arms, hinged together.

At least one of the magnets 105 and 109 may be an electromagnet. The other magnet may be a permanent magnet or an electromagnet. The magnets 105 and 109 may be positioned so that both of their north or south poles face each other and so that they move closer together as force is applied to the power-assist brake pedal 115. Each of the magnets 105 and 109 may include multiple magnets.

The magnetic field between the magnets 105 and 109 may apply a repulsive force 107 to the linkage 111 and, in turn, to the brake pedal arm 113, and then to the power-assist brake pedal pad 115, and then to a foot of a vehicle operator that is depressing the power-assist brake-pedal pad 115. As the magnets 105 and 109 move closer together, the amount of the repulsive force 107 that the magnet 105 transfers to the power-assist brake pedal pad 115 may increase, assuming that the current to the electromagnet(s) does not decrease.

There may be no other mechanical components within the electromagnetic movement resistance device 103 that apply force to the power-assist brake pedal pad 115. For example, there may be no springs, hydraulically-actuated components, and/or vacuum-actuated components.

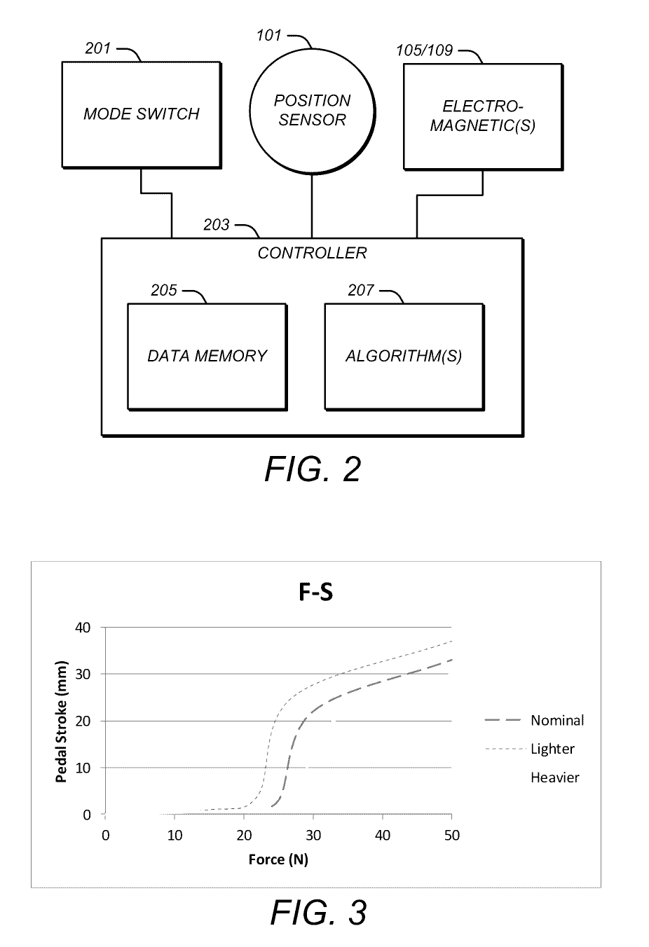

FIG. 2 illustrates an example of electronic components that may be used in connection with the variable electromagnetic brake pedal feel simulation system illustrated in FIG. 1. As illustrated in FIG. 2, these electrical components may include a mode switch 201, the position sensor 101, the electromagnet(s) 105 and/or 109, and a controller 203 that may include a data memory 205 and/or an algorithm(s) 207 that may be contained within a memory which could be the memory 205 or a different memory.

The mode switch 201 may be a mechanical switch that enables a user of the electromagnetic brake pedal feel simulation system to select one of multiple modes of operation of a vehicle in which the electromagnetic brake pedal feel simulation system is installed. The modes of operation may include a normal mode, a sports mode, and/or a racing mode. In another configuration, the modes of operation may include a normal mode when the vehicle is carrying a normal load, a lighter mode when the vehicle is carrying a light load, and a heavier mode when the vehicle is carrying a heavy load. In a still further configuration, the modes of operation may correspond to different types of vehicles. This may enable the same variable electromagnetic brake pedal feel simulation system hardware to be installed in different types of vehicles and to provide a different position/force profile in connection with each different type of vehicle, based on the mode that is selected by the mode switch 201.

The position sensor 101 may provide information to the controller 203 indicative of the position of the power-assisted brake pedal 115. The information may be in any form. For example, the information may be representative of the angular position of the brake pedal arm 113 or the linear position of the power-assist brake pedal pad 115.

The controller 203 may control the amount of current that is initially delivered to the electromagnet(s) 105 and/or 109 when the power-assist brake pedal pad 115 is in its fully raised position and, thereafter, modify that amount of current based on the position of the power-assist brake pedal pad 115, as detected by the position sensor 101. For example, the controller 203 may deliver a pre-determined amount of current to the electromagnet(s) 105 and/or 109 when the power-assist brake pedal pad 115 has no force applied to it and may then adjust this amount upwardly as the power-assist brake pedal pad 115 is depressed. The amount of the initial current and later adjustments may be set so as to cause the repulsive force between the magnets 105 and 109 at each of their possible separation distances to approximately replicate the amount of force that would normally be applied against a manual brake pedal at its different positions.

Similarly, the controller 203 may instead control the amount of current that is initially and thereafter delivered to the electromagnet(s) 105 and/or 109 based on the setting of the mode switch 201. For example, the controller 203 may deliver a lower amount of current when a normal mode is selected on the mode switch 201, a somewhat higher amount when a sport mode is selected, and an even higher amount when a race mode is selected. In each case, the amount of the current may again be set so as to cause the repulsive force between the magnets 105 and 109 to replicate the amount of force that would normally be applied against a manual brake pedal when the vehicle is driven in these different modes.

The controller 203 may also control the amount of current that is initially and thereafter delivered to the electromagnet(s) 105 and/or 109 based on both the setting of the mode switch 201 and the position of the power-assist brake pedal 115, as detected by the position sensor 101. For example, there may be a different amount of current that is initially applied to the electromagnet(s) 105 and/or 109 for each different mode that is selected. Similarly, for each of the different modes, there may be a different amount of current that is thereafter applied to the electromagnet(s) 105 and/or 109 when in each of its different positions.

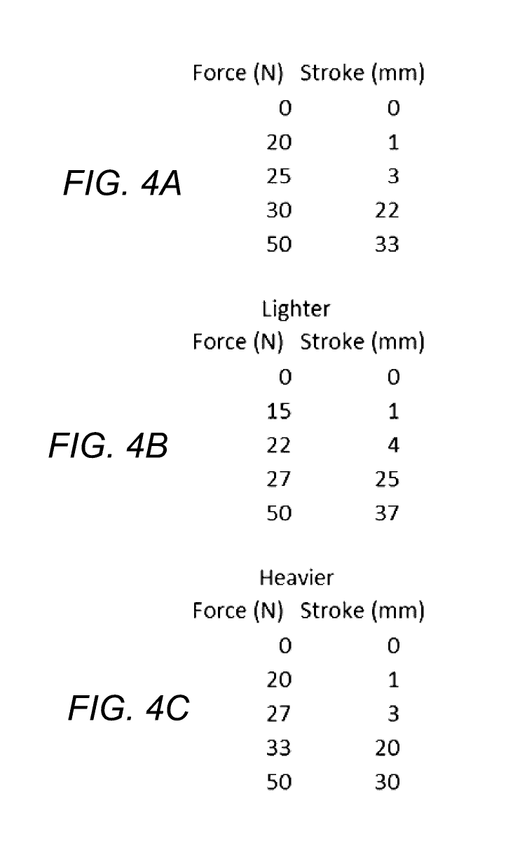

FIG. 3 illustrates graphs of example amounts of repulsive force that the controller 203 may cause the magnets 105 and 109 to apply to the power-assist brake pedal pad 115 at different positions of the power-assist brake pedal pad 115 and during each of three different modes of operation (designated in the figure as “normal,” “lighter,” and “heavier.”). FIGS. 4A-4C illustrate some of the same data in a table format.

To facilitate this functionality, the data memory 205 may contain data indicative of the amount of drive current that the controller 203 should deliver to the electromagnet(s) 105 and/or 109 when the power-assist brake pedal pad 115 is at various different positions, as detected by the position sensor 101, and/or for each of its various different modes. When the power-assist brake pedal pad 115 is at a position that does not precisely correspond with a position indicated by the data in the data memory 205, the controller 203 may interpolate between the amount of drive current that is indicated by the data in the data memory 205 for the two positions that are closest to the actual position of the power-assist brake pedal pad 115 for each mode, use the amount of current that is associated with the closest position that is in memory for each mode, or use any other algorithmic approach to generating an appropriate current level based on this stored data for each mode.

The controller 203 may in addition or instead use one or more of the algorithm(s) 207 to determine the amount of drive current that the controller 203 should deliver to the electromagnet(s) 105 and/or 109 based on changes in the position of the power-assist brake pedal pad 115, as sensed by the position sensor 101, and/or the mode that is selected. One such algorithm, for example, may regulate the drive current based on the square or square root of the distance the power-assist brake pedal pad 115 travels or based on any other appropriate mathematical function.

The controller 203 may be a computer system configured to perform the functions that have been described herein for the component. Each computer system may include one or more processors, tangible memories (e.g., random access memories (RAMs), read-only memories (ROMs), and/or programmable read only memories (PROMS)), tangible storage devices (e.g., hard disk drives, CD/DVD drives, and/or flash memories), system buses, network communication components, input/output ports, and/or user interface devices. The computer system may include software (e.g., one or more operating systems, device drivers, application programs, and/or communication programs). When software is included, the software may include programming instructions and may include associated data and libraries. When included, the programming instructions are configured to implement one or more algorithms that implement one or more of the functions of the controller, as recited herein. The description of each function that is performed by the controller also constitutes a description of the algorithm(s) that performs that function.

The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and/or advantages. These also include embodiments in which the components and/or steps are arranged and/or ordered differently.

For example, the techniques that are described herein may be applied to a throttle, brake, and/or clutch control on automobiles, motorcycles, watercraft, and military vehicles. The techniques could be used for any application of a control (lever, button, etc.) that requires force feedback to the user applying the control.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. An electromagnetic brake pedal feel simulation system for simulating the feel of a manual brake pedal when force is applied to a power-assist brake pedal pad mounted to an arm, the electromagnetic brake pedal feel simulation system comprising:
an electromagnetic movement resistance device that mechanically couples to the power-assist brake pedal pad or arm and that applies a controllable amount of force against a braking force that is applied to a power-assist brake pedal that is a function of the amount of a drive signal current, the electromagnetic movement resistance device including a pair of magnets having both of their north or south poles facing each other and that come closer together as force is applied to the power-assist brake pedal, at least one of the magnets being an electromagnetic to which the drive signal current is applied;
a brake pedal position sensor that senses the position of the power-assist brake pedal pad or arm; and
a controller electrically connected to the at least one electromagnet and to the brake pedal position sensor and that causes the amount of the drive signal current to vary based on the position of the power-assist brake pedal pad or arm, as sensed by the sensor.

2. The electromagnetic brake pedal feel simulation system of claim 1 wherein the controller includes a memory containing data indicative of an amount of drive signal current that the controller should cause to be applied to the at least one electromagnet for each of multiple different positions of the power-assist brake pedal pad or arm, as sensed by the sensor.

3. The electromagnetic brake pedal feel simulation system of claim 1 wherein the controller uses an algorithm to determine the amount of drive signal current that the controller should cause to be applied to the at least one electromagnet based on the position of the power-assist brake pedal pad or arm, as sensed by the sensor.

4. The electromagnetic brake pedal feel simulation system of claim 1 wherein one of the magnets is a permanent magnet.

5. The electromagnetic brake pedal feel simulation system of claim 1 wherein both of the magnets are electromagnetic.

6. The electromagnetic brake pedal feel simulation system of claim 1 wherein the pair of magnets move in unison with movement of the power-assist brake pedal pad or arm.

7. The electromagnetic brake pedal feel simulation system of claim 1 wherein the controller:
includes a mode switch that enables a user of the electromagnetic brake pedal feel simulation system to select one of multiple modes of operation of a vehicle in which the electromagnetic brake pedal feel simulation system is installed; and
causes the amount of drive signal current to vary based on the mode of operation selected by the user.

8. The electromagnetic brake pedal feel simulation system of claim 7 wherein the multiple modes of operation include a normal mode, a sport mode, and a racing mode.

9. The electromagnetic brake pedal feel simulation system of claim 8 wherein the controller includes a memory containing data indicative of an amount of drive signal current that the controller should cause to be applied to the at least one electromagnet for each of multiple different positions of the power-assist brake pedal pad or arm, as sensed by the sensor, during each of the multiple modes.

10. The electromagnetic brake pedal feel simulation system of claim 8 wherein the controller uses an algorithm to determine the amount of drive signal current that the controller should cause to be applied to the at least one electromagnet for each of the multiple different positions of the power-assist brake pedal pad or arm, as sensed by the sensor, and during each of the multiple modes.

11. An electromagnetic brake pedal feel simulation system for simulating the feel of a manual brake pedal during power-assist breaking, the electromagnetic brake pedal feel simulation system comprising:
an electromagnetic movement resistance device that mechanically couples to a power-assist brake pedal pad or arm and that applies a controllable amount of force against a braking force that is applied to the power-assist brake pedal pad that is a function of the amount of a drive signal current, the electromagnetic movement resistance device including a pair of magnets having both of their north or south poles facing each other and that come closer together as force is applied to the power-assist brake pedal, at least one of the magnets being an electromagnetic to which the drive signal current is applied;
a mode switch that enables a user of the electromagnetic brake pedal feel simulation system to select one of multiple modes of operation of a vehicle in which the electromagnetic brake pedal feel simulation system is installed; and
a controller electrically connected to the at least one electromagnet and to the brake pedal movement sensor and having a configuration that causes the amount of the drive signal current to vary based on the mode of operation selected by the user.

12. The electromagnetic brake pedal feel simulation system of claim 11 wherein the multiple modes of operation include a normal mode, a sport mode, and a racing mode.

13. The electromagnetic brake pedal feel simulation system of claim 11 wherein the controller includes a memory containing data indicative of an amount of drive signal current that the controller should cause to be applied to the at least one electromagnet during each of the multiple modes.

14. The electromagnetic brake pedal feel simulation system of claim 11 wherein the controller computes a mathematical function to determine the amount of drive signal current that the controller should cause to be applied to the at least one electromagnet during each of the multiple modes.

15. The electromagnetic brake pedal feel simulation system of claim 11 wherein one of the magnets is a permanent magnet.

16. The electromagnetic brake pedal feel simulation system of claim 11 wherein both of the magnets are electromagnetic.

17. The electromagnetic brake pedal feel simulation system of claim 11 wherein the pair of magnets move in unison with movement of the power-assist brake pedal pad or arm.

18. Two vehicles that each contain an electromagnetic brake pedal feel simulation system for simulating the feel of a manual brake pedal during power-assist breaking, the electromagnetic brake pedal feel simulation system in each vehicle being identical in hardware, but providing a materially different brake pedal feel simulation.

19. The two vehicles of claim 18 wherein each of the electromagnetic brake pedal feel simulation systems includes a memory containing data indicative of how the simulation should feel and wherein the data in each memory is different.

20. The two vehicles of claim 18 wherein each of the electromagnetic brake pedal feel simulation systems uses an algorithm to indicate how the simulation should feel and wherein the algorithm in each system is different.
